(19) United States
(12) Patent Application Publication
(10) Pub. No.: US 2022/0210167 A1
(43) Pub. Date: Jun. 30, 2022

(54) CONTEXT-AWARE INTRUSION DETECTION SYSTEM

(71) Applicant: VMware, Inc., Palo Alto, CA (US)

(72) Inventors: Venkatakrishnan RAJAGOPALAN, Santa Clara, CA (US); Sirisha MYNENI, Santa Clara, CA (US); Srinivas RAMASWAMY, Cupertino, CA (US); Nafisa MANDLIWALA, Santa Clara, CA (US); Robin MANHAS, Cupertino, CA (US)

(73) Assignee: VMware, Inc., Palo Alto, CA (US)

(21) Appl. No.: 17/137,385

(22) Filed: Dec. 30, 2020

(51) Int. Cl. H04L 29/06; G06F 9/455

(52) U.S. Cl. CPC H04L 63/1416; H04L 63/1425; G06F 9/45558; G06F 2009/45591; G06F 2009/45595; G06F 2009/4557; G06F 9/45545

(57) ABSTRACT

Example methods and systems for context-aware intrusion detection are described. In one example, in response to determination that there is a matching intrusion detection signature based on packet flow information associated with a packet, a computer system may generate an intrusion detection alert that identifies the matching intrusion detection signature and the packet flow information. Further, the computer system may map the intrusion detection alert to contextual information, and generate a context-aware intrusion detection alert to trigger a context-aware remediation action based on at least the contextual information. The intrusion detection alert may be enhanced with context information associated with at least one of the following: the virtualized computing instance, a client device associated with the virtualized computing instance, and a user operating the client device.

### BACKGROUND

Virtualization allows the abstraction and pooling of hardware resources to support virtual machines in a software-defined data center (SDDC). For example, through server virtualization, virtualized computing instances such as virtual machines (VMs) running different operating systems may be supported by the same physical machine (e.g., host). Each VM is generally provisioned with virtual resources to run a guest operating system and applications. The virtual resources may include central processing unit (CPU) resources, memory resources, storage resources, network resources, etc. In practice, it is desirable to detect potential security threats that may affect the performance of hosts and VMs in the SDDC.

### BRIEF DESCRIPTION OF DRAWINGS

FIG. 1 is a schematic diagram illustrating an example software-defined networking (SDN) environment in which context-aware intrusion detection may be performed;

FIG. 2 is a schematic diagram illustrating an example computer system for context-aware intrusion detection in an SDN environment;

FIG. 3 is a flowchart of an example process for a computer system to perform context-aware intrusion detection;

FIG. 4 is a flowchart of an example detailed process for a computer system to perform context-aware intrusion detection;

FIG. 5 is a schematic diagram illustrating an example context-aware intrusion detection; and

FIG. 6 is a schematic diagram illustrating an example context-aware intrusion detection alert.

### DETAILED DESCRIPTION

According to examples of the present disclosure, context-aware intrusion detection may be implemented to improve data center security. For example, a computer system may be configured to generate context-aware intrusion detection alerts by mapping intrusion detection alerts to associated context information. This way, context-aware intrusion detection alerts may be generated to provide additional context information relating to potential security threats. Remediation action(s) may also be triggered based on at least the context information. Depending on the desired implementation, the context information may be associated with a virtualized computing instance, a client device associated with the virtualized computing instance, a user operating the client device, or any combination thereof.

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the drawings, can be arranged, substituted, combined, and designed in a wide variety of different configurations, all of which are explicitly contemplated herein.

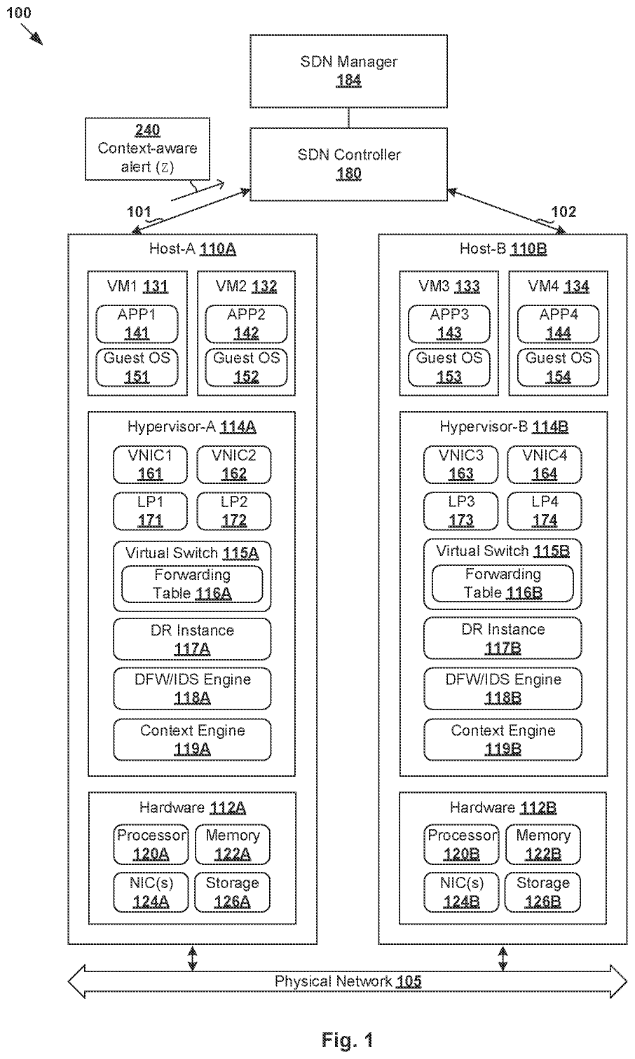

FIG. 1 is a schematic diagram illustrating example software-defined networking (SDN) environment 100 in which context-aware intrusion detection may be performed. It should be understood that, depending on the desired implementation, SDN environment 100 may include additional and/or alternative components than that shown in FIG. 1. Although the terms “first” and “second” are used to describe various elements, these elements should not be limited by these terms. These terms are used to distinguish one element from another. For example, a first element may be referred to as a second element, and vice versa.

SDN environment 100 includes multiple hosts 110A-B that are inter-connected via physical network 105. Each host 110A/110B may include suitable hardware 112A/112B and virtualization software (e.g., hypervisor-A 114A, hypervisor-B 114B) to support various virtual machines (VMs). For example, hosts 110A-B may support respective VMs 131-134. Hardware 112A/112B includes suitable physical components, such as central processing unit(s) or processor(s) 120A/120B; memory 122A/122B; physical network interface controllers (NICs) 124A/124B; and storage disk(s) 126A/126B. Note that SDN environment 100 may include any number of hosts (also known as a “host computers”, “host devices”, “physical servers”, “server systems”, “transport nodes,” etc.), where each host may be supporting tens or hundreds of VMs.

Hypervisor 114A/114B maintains a mapping between underlying hardware 112A/112B and virtual resources allocated to respective VMs. Virtual resources are allocated to respective VMs 131-134 to support a guest operating system and application(s); see 141-144, 151-154. Any suitable applications 141-144 may be implemented, such as user-space and/or kernel-space processes/applications labelled “APP1 ” to “APP4.” For example, virtual resources may include virtual CPU, guest physical memory, virtual disk, virtual network interface controller (VNIC), etc. Hardware resources may be emulated using virtual machine monitors (VMMs). For example, VNICs 161-164 are virtual network adapters for respective VMs 131-134. Each VNIC may be emulated by a corresponding VMM (not shown) instantiated by hypervisor 114A/114B. The VMMs may be considered as part of respective VMs, or alternatively, separated from the VMs. Although one-to-one relationships are shown, one VM may be associated with multiple VNICs (each VNIC having its own network address).

Although examples of the present disclosure refer to VMs, it should be understood that a “virtual machine” running on a host is merely one example of a “virtualized computing instance” or “workload.” A virtualized computing instance may represent an addressable data compute node (DCN) or isolated user space instance. In practice, any suitable technology may be used to provide isolated user space instances, not just hardware virtualization. Other virtualized computing instances may include containers (e.g., running within a VM or on top of a host operating system without the need for a hypervisor or separate operating system or implemented as an operating system level virtualization), virtual private servers, client computers, etc. Such container technology is available from, among others, Docker, Inc. The VMs may also be complete computational environments, containing virtual equivalents of the hardware and software components of a physical computing system.

The term “hypervisor” may refer generally to a software layer or component that supports the execution of multiple virtualized computing instances, including system-level software in guest VMs that supports namespace containers such as Docker, etc. Hypervisors 114A-B may each implement any suitable virtualization technology, such as VMware ESX® or ESXi™ (available from VMware, Inc.), Kernel-based Virtual Machine (KVM), etc. The term “packet” may refer generally to a group of bits that can be transported together, and may be in another form, such as “frame,” “message,” “segment,” etc. The term “traffic” or “flow” may refer generally to multiple packets. The term “layer-2” may refer generally to a link layer or media access control (MAC) layer; “layer-3” to a network or Internet Protocol (IP) layer; and “layer-4” to a transport layer (e.g., using Transmission Control Protocol (TCP), User Datagram Protocol (UDP), etc.), in the Open System Interconnection (OSI) model, although the concepts described herein may be used with other networking models.

Hypervisor 114A/114B implements virtual switch 115A/115B and logical distributed router (DR) instance 117A/117B to handle egress packets from, and ingress packets to, corresponding VMs. In SDN environment 100, logical switches and logical DRs may be implemented in a distributed manner and can span multiple hosts. For example, logical switches that provide logical layer-2 connectivity, i.e., an overlay network, may be implemented collectively by virtual switches 115A-B and represented internally using forwarding tables 116A-B at respective virtual switches 115A-B. Forwarding tables 116A-B may each include entries that collectively implement the respective logical switches. Further, logical DRs that provide logical layer-3 connectivity may be implemented collectively by DR instances 117A-B and represented internally using routing tables (not shown) at respective DR instances 117A-B. The routing tables may each include entries that collectively implement the respective logical DRs.

Packets may be received from, or sent to, each VM via an associated logical port. For example, logical switch ports 171-174 are associated with respective VMs 131-134. Here, the term “logical port” or “logical switch port” may refer generally to a port on a logical switch to which a virtualized computing instance is connected. A “logical switch” may refer generally to a software-defined networking (SDN) construct that is collectively implemented by virtual switches 115A-B in FIG. 1, whereas a “virtual switch” may refer generally to a software switch or software implementation of a physical switch. In practice, there is usually a one-to-one mapping between a logical port on a logical switch and a virtual port on virtual switch 115A/115B. However, the mapping may change in some scenarios, such as when the logical port is mapped to a different virtual port on a different virtual switch after migration of the corresponding virtualized computing instance (e.g., when the source host and destination host do not have a distributed virtual switch spanning them).

Through virtualization of networking services in SDN environment 100, logical networks (also referred to as overlay networks or logical overlay networks) may be provisioned, changed, stored, deleted and restored programmatically without having to reconfigure the underlying physical hardware architecture. A logical network may be formed using any suitable tunneling protocol, such as Virtual eXtensible Local Area Network (VXLAN), Stateless Transport Tunneling (STT), Generic Network Virtualization Encapsulation (GENEVE), etc. For example, VXLAN is a layer-2 overlay scheme on a layer-3 network that uses tunnel encapsulation to extend layer-2 segments across multiple hosts which may reside on different layer 2 physical networks. In the example in FIG. 1, VM1 131 on host-A 110A and VM3 133 on host-B 110B may be connected to the same logical switch and located on the same logical layer-2 segment, such as a segment with virtual network identifier (VNI)=6000.

SDN controller 180 and SDN manager 184 are example network management entities in SDN environment 100. One example of an SDN controller is the NSX controller component of VMware NSX® (available from VMware, Inc.) that operates on a central control plane. SDN controller 180 may be a member of a controller cluster (not shown for simplicity) that is configurable using SDN manager 184 operating on a management plane. Network management entity 180/184 may be implemented using physical machine(s), VM(s), or both. Logical switches, logical routers, and logical overlay networks may be configured using SDN controller 180, SDN manager 184, etc. To send or receive control information, a local control plane (LCP) agent (not shown) on host 110A/110B may interact with central control plane (CCP) module 182 at SDN controller 180 via control-plane channel 101/102.

Hosts 110A-B may also maintain data-plane connectivity with each other via physical network 105 to facilitate communication among VMs 131-134. Hypervisor 114A/114B may implement a virtual tunnel endpoint (VTEP) (not shown) to encapsulate and decapsulate packets with an outer header (also known as a tunnel header) identifying the relevant logical overlay network (e.g., VNI). For example in FIG. 1, hypervisor-A 114A implements a first VTEP associated with (IP address=IP-A, VTEP label=VTEP-A). Hypervisor-B 114B implements a second VTEP with (IP-B, VTEP-B). Encapsulated packets may be sent via an end-to-end, bi-directional communication path (known as a tunnel) between a pair of VTEPs over physical network 105.

One of the challenges in SDN environment 100 is improving the overall data center security. To protect VMs 131-134 against security threats caused by unwanted packets, hypervisor 114A/114B may implement intrusion detection system (IDS) engine and/or distributed firewall (DFW) engine 118A/118B to filter packets to and from associated VMs 131-134. In one example, IDS and DFW engines that have separate functionalities may work with each other on host 110A/110B. For example, at host-A 110A, hypervisor 114A implements IDS engine 118A to filter packets for VM1 131 and VM2 132. SDN controller 180 may be used to configure IDS signatures or firewall rules. In practice, packets may be filtered at any point along the datapath from a source (e.g., VM1 131) to a physical NIC (e.g., 124A). In one embodiment, a filter component (not shown) may be incorporated into each VNIC 141-144 to perform intrusion detection configured for respective VMs 131-134.

Context-Aware Intrusion Detection

According to examples of the present disclosure, context-aware intrusion detection may be performed to improve defense against potential security threats in SDN environment 100. As used herein, the term “context-aware” may refer generally to an approach that is capable of associating context information with a possible intrusion or security threat. The “context information” may be associated with a virtualized computing instance (e.g., VM, process, application), a physical device (e.g., client device), a user, etc. This way, context-aware intrusion alerts may be generated to trigger remediation action(s) based on at least on the context information. Examples of the present disclosure may be implemented to improve data center security and reduce system downtime due to malicious attacks.

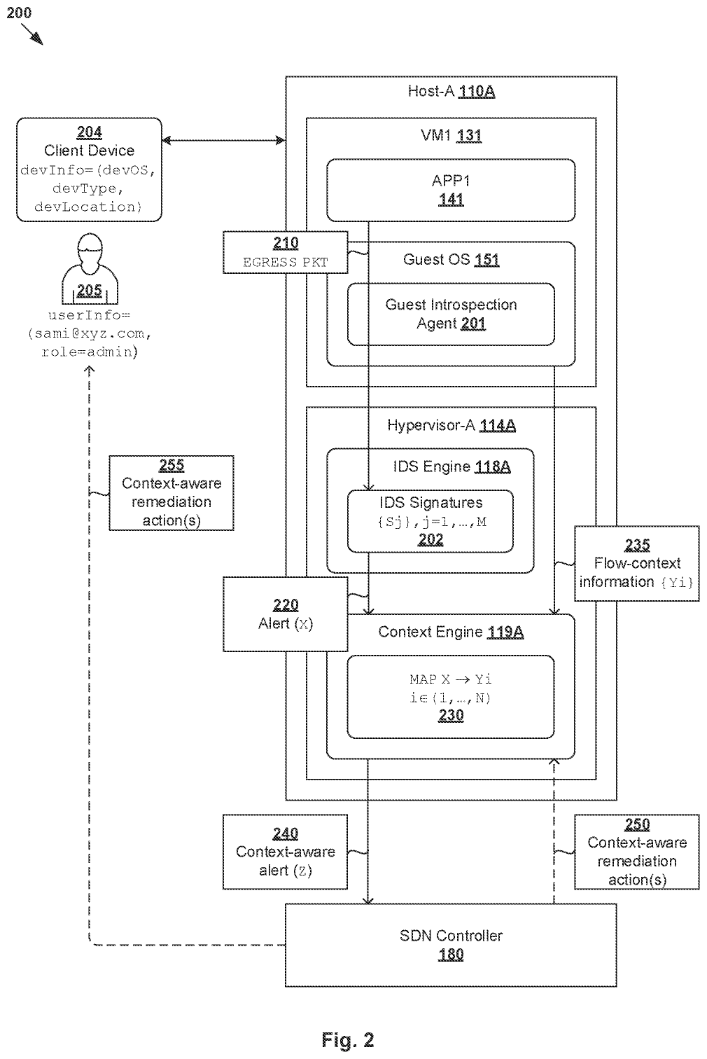

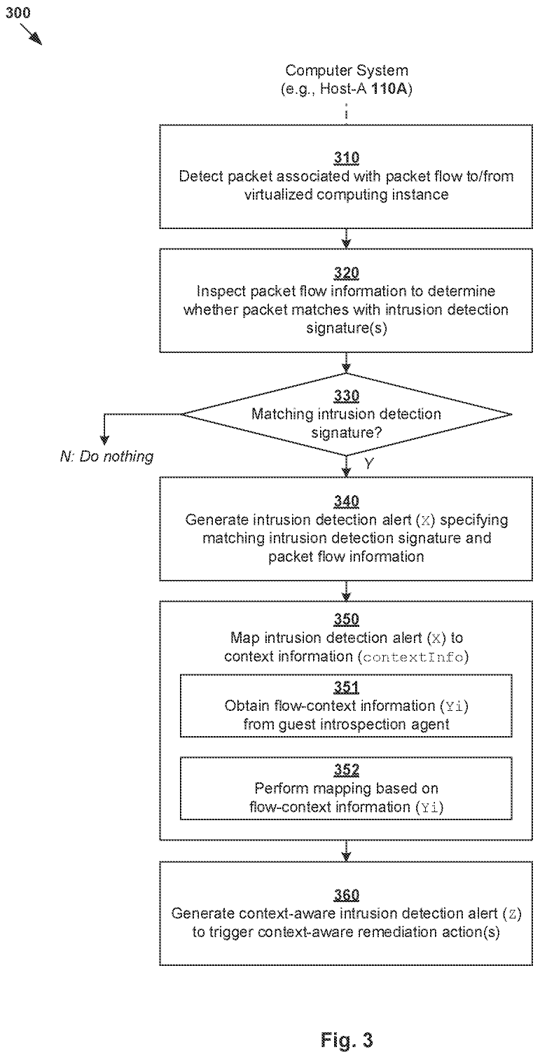

In more detail, FIG. 2 is a schematic diagram illustrating example computer system for context-aware intrusion detection 200 in SDN environment 100. The example in FIG. 2 will be discussed using FIG. 3, which is a flowchart of example process 300 for a computer system to perform context-aware intrusion detection. Example process 300 may include one or more operations, functions, or actions illustrated by one or more blocks, such as 310 to 360. The various blocks may be combined into fewer blocks, divided into additional blocks, and/or eliminated depending on the desired implementation.

In the example in FIG. 2, host-A 110A may support IDS engine 118A, context engine 119A and guest introspection agent 201 to perform context-aware intrusion detection. Depending on the desired implementation, IDS engine 118A and context engine 119A may be user-space (or user-world) processes running on hypervisor-A 114A. Guest introspection agent 201 may be running on guest OS 151 to monitor events associated with VM1 131. In the following, various examples will be discussed using host-A 110A as an example “computer system” and VM1 131 as an example “virtualized computing instance” and SDN controller 180 as an example “management entity.” Note that other hosts (e.g., host-B 110B) may be configured in a similar manner to perform examples of the present disclosure.

At 210 in FIGS. 2 and 310-320 in FIG. 3, host-A 110A may detect and inspect a packet that is travelling from VM1 131 (e.g., egress packet in FIG. 2) or towards VM1 131 (i.e., ingress packet; not shown). Block 220 may involve inspecting any suitable “packet flow information” associated the packet, such as header and/or payload information. Example packet flow information may include tuple information specified by the packet such as source IP address, destination IP address, source port number, destination port number, protocol, or any combination thereof. Alternatively or additionally, the packet flow information may be information that is derivable from the packet, such as packet flow metric(s), metadata associated with the packet, etc.

At 220 in FIGS. 2 and 330-340 in FIG. 3, in response to determination that there is a matching intrusion detection signature based on the packet flow information, host-A 110A may generate an intrusion detection alert (X). The matching intrusion detection signature may be identified by IDS engine 118A running on hypervisor-A 114A by matching the packet flow information to one of multiple intrusion detection signatures 202. The intrusion detection alert (X) may be generated to identify the matching intrusion detection signature and the packet flow information.

At 230 in FIGS. 2 and 350 in FIG. 3, host-A 110A may map the intrusion detection alert (X) to contextual information associated with VM1 131, a client device (see 204 in FIG. 2) associated with VM1 131, a user (see 205 in FIG. 2) operating the client device, or any combination thereof. Depending on the desired implementation, block 350 may involve context engine 119A obtaining, from guest introspection agent 201 running inside VM1 131, a set of flow-context information (Yi, i=1, . . . ,N) associated with multiple (N) packet flows to/from VM1 131. This way, the intrusion detection alert (X) may be mapped to one of the multiple (N) packet flows and associated context information. See also 235 in FIGS. 2 and 351-352 in FIG. 3.

At 240 in FIGS. 2 and 360 in FIG. 3, host-A 110A may generate a context-aware intrusion detection alert (Z), being the intrusion detection alert that is enhanced with the contextual information, to trigger context-aware remediation action(s) based on at least the contextual information. For example, block 360 may involve host-A 110A sending the context-aware intrusion detection alert to SDN controller 180 or any other management entity (see also 240 in FIG. 2). To implement the context-aware remediation action(s), SDN controller 180 may instruct host-A 110A (see 250 in FIG. 2) and/or client device 204 (see 255). The remediation action(s) may be associated VM1 131 (e.g., block further activity or events initiated by APP1 141), client device 204 (e.g., send upgrade instructions) or user 205 (e.g., block further activity by this user).

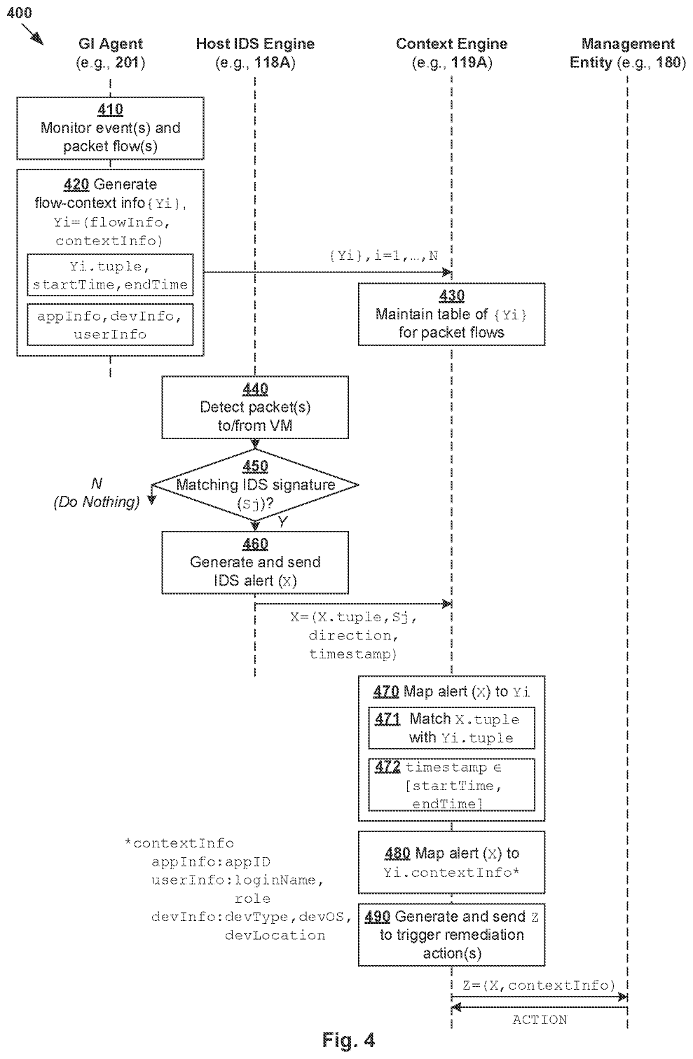

As will be described using FIGS. 4-6, block 350 may involve guest introspection agent 201 monitoring multiple (N) packet flows associated with VM1 131 to generate the flow-context information (Yi, i=1, . . . ,N). Context engine 119A may map the intrusion detection alert (X) generated by IDS engine 118A to a particular packet flow monitored by guest introspection agent 201. The mapping process may involve comparing (a) an alert timestamp associated with the intrusion detection alert (X) with (b) a start time and/or end time associated with the particular packet flow based on the flow-context information (Yi).

Depending on the desired implementation, block 350 may include mapping the intrusion detection alert to any one of the following: (a) a process or application (e.g., APP1 141) that is running on VM1 131 and responsible for the intrusion detection alert; (b) hardware information, software information or location information associated with client device 204 responsible for the alert; and (c) user information associated with user 205 responsible for the alert. This way, context-aware remediation action(s) may be triggered based on (a) the process or application; (b) hardware information, software information or location information associated with client device 204; or (c) user information associated with user 205.

Using examples of the present disclosure, alerts generated by IDS engine 118A may be enhanced using context information obtained from guest introspection agent 201 running inside VM1 131. This provides an improvement over conventional approaches that provide relatively limited information associated with a security threat.

Such conventional approaches may be lack efficiency because further (manual) investigations and troubleshooting by a network administrator may be required. In contrast, examples of the present disclosure may be implemented to provide substantially rich context information associated with a security threat. Based on the context information, context-aware remediation action(s) may be triggered to protect against similar attacks in the future. Various examples will be discussed below.

### Detailed Examples

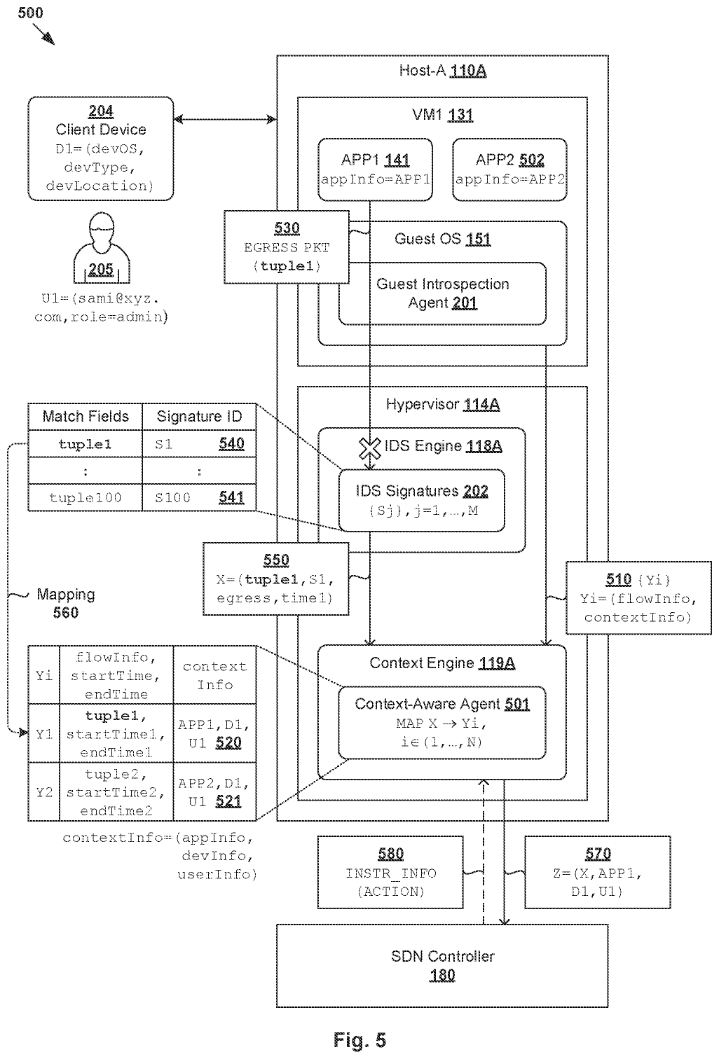

FIG. 4 is a flowchart of example detailed process 400 for a computer system to perform context-aware intrusion detection. Example process 400 may include one or more operations, functions, or actions illustrated at 410 to 490. The various operations, functions or actions may be combined into fewer blocks, divided into additional blocks, and/or eliminated depending on the desired implementation. The example in FIG. 4 will be explained using FIG. 5, which is a schematic diagram illustrating example 500 of context-aware intrusion detection.

(a) Flow-context information

At 410-420 in FIG. 4, guest introspection agent 201 may be configured to monitor events and multiple (N) packet flows associated with VM1 131 to collect generate associated flow-context information (Yi, i=1, . . . ,N). For a particular (ith) packet flow, its flow-context information (Yi) may specify packet flow tuple information (Yi.tuple), packet flow start time (startTime), packet flow end time (endTime) and context information (contextInfo).

Depending on the desired implementation, guest introspection agent 201 may register hooks (e.g., callbacks) with kernel-space or user-space module(s) implemented by guest OS 151 for new network connection events, process events, etc. For example, in response to detecting a new secure shell (SSH) session initiated by VM1 131, guest introspection agent 201 receives a callback from the guest OS and sends context information to context engine 118A. In practice, guest introspection agent 201 may be a guest OS driver configured to interact with packet processing operations taking place at multiple layers in a networking stack of guest OS 151 and intercept file and/or network-related events. Guest introspection agent 201 may also check if an IDS alert is a false positive.

Any suitable “context information” may be obtained, such as application information (appInfo) associated with APP1 141, device information (devInfo) associated with client device 204, user information (userInfo) associated with user 205, or any combination thereof. Any suitable approach may be used by guest introspection agent 201 to obtain context information, examples of which are described in related U.S. patent application Ser. No. 15/836,888 entitled “Context based firewall services for data message flows for multiple concurrent users on one machine,” the content of which is incorporated herein in its entirety.

Example application information (appInfo) may include application identifier (ID), application name, process hash, application path with command line parameters, resource consumption information (e.g., CPU consumption, network consumption, memory consumption, etc.) associated with application, application version, security level associated with application, etc. Example user information (userInfo) may include login name and role (e.g., sami@xyz.com and role=admin in FIG. 2), user ID, group ID associated with user, etc. Example device information (devInfo) may include hardware and/or software information, such as OS information (devOS) including OS type and version; device type (devType) such as laptop and mobile phone; International Mobile Equipment Identity (IMEI) number; device model or brand, etc. The device information may further include location information (devLocation) of client device 204, etc.

At 430 in FIG. 4, context engine 119A may obtain and store the flow-context information (Yi, i=1, . . . ,N) from guest introspection agent 201. The term “obtaining” may refer generally to retrieving or receiving information from guest introspection agent 201 or any suitable datastore (e.g., memory). In the example in FIG. 5, consider a scenario where client device 204 operated by user 205 (e.g., login name=sami@xyz.com, role=admin) accesses VM1 131 from a remote location. Client device 204 may connect with VM1 131 using any suitable approach, such as via virtual private network (VPN) connection. Based on instructions from client device 204, multiple applications or processes may run on VM1 131, such as APP1 141 and APP2 502. In this case, context engine 119A may obtain flow-context information associated with two (N=2) packet flows from guest introspection agent 201. See 510 in FIG. 5.

Referring now 520 in FIG. 5, a first table entry (Y1) associated with a first packet flow from APP1 141 may specify first packet flow information=(Y1. tuple1, startTime1, endTime1) that is mapped with first context information=(APP1, D1, U1). Here, Y1. tuple1=first tuple information may include source IP address=IP-VM1, destination IP address=IP-VM3, source port number (SPN), destination port number (DPN)=80, protocol=HTTP, etc. If available, start time and end time of the first packet flow (e.g., TCP connection) are respectively denoted as (startTime1, endTime1). The context information may include application ID=APP1 associated with APP1 141, D1=device information associated with client device 204, and U1=user information associated with user 205.

At 521 in FIG. 5, a second table entry (Y2) associated with a second packet flow from APP1 502 may specify second packet flow information=(Y2. tuple2, startTime2, endTime2) mapped with second context information=(APP2, D1, U1). Here, Y2. tuple2=second tuple information may include (source IP address=IP-VM1, destination IP address=IP-VM4, SPN, DPN=443, protocol=HTTPS). If available, start time and end time of the second packet flow are respectively denoted as (startTime2, endTime2). The context information may include APP2=application ID of APP2 502, D1 (e.g., OS version, device type and location) and U1 (e.g., login name and role).

(b) Intrusion detection alert (X)

At 440-450 in FIG. 4, in response to detecting packet(s) travelling to/from VM1 131, IDS engine 118A may inspect packet flow information associated with packet(s) to determine whether there is a matching intrusion detection signature. If yes (signature matched), an intrusion detection alert (X) may be generated and sent to context engine 119A. Depending on user's configuration, the packet(s) may be blocked or dropped. Otherwise (no match), the packet(s) are allowed to travel towards their destination. IDS signatures 202 may be configured to detect any suitable security threat. The term “security threat” or “malware” may be used as an umbrella term to cover hostile or intrusive software, including but not limited to botnets, viruses, worms, Trojan horse programs, spyware, phishing, adware, riskware, rootkits, spams, scareware, ransomware, or any combination thereof.

In the example in FIG. 5, IDS engine 118A may detect an egress packet (see 530) that belongs to the first packet flow from APP1 141 and match the egress packet to one of multiple (M) IDS signatures 202 denoted as Sj,j=1, . . . ,M. Each IDS signature (Sj) may specify match fields to be matched to packet(s) and corresponding signature ID (see 540-541). For example, IDS engine 118A may match egress packet 510 to a first IDS signature (S1) based on a comparison between (a) the packet flow information (tuple1) specified by egress packet 510 and (b) match fields 540 specified by S1 (see 540). In response to detecting a match, IDS engine 118A may generate and send, to context engine 119A, an intrusion detection alert denoted as X=(X. tuple1, signature ID=S1, direction=egress, timestamp=time1). See 550 in FIG. 5.

(c) Context-aware intrusion detection alert (Z)

At 470 in FIG. 4, context engine 119A may map the alert (X) to the flow-context information (Yi) associated with a particular flow, such as using context-aware agent 501. At 471, the mapping process may involve comparing X. tuple1 specified by the alert (X) with corresponding Y1. tuple1 specified by the flow-context information (Y1) (see 520). At 472, the mapping process may further include comparing (a) an alert timestamp=timet specified by the alert (X) with (b) (startTime1, endTime1) associated with the first packet flow and specified by the flow-context information (Y1). See also “Mapping” 560 in FIG. 5.

At 480 in FIG. 4, context engine 119A may map the alert (X) to context information=(APP1, D1, U1) based on the flow-context information (Y1) associated with the first packet flow. In one example, block 480 may involve map the alert (X) to a process or application (e.g., APP1 141) that is running inside the virtualized computing instance and responsible for the alert (X). In another example, the alert (X) may be mapped to hardware information, software information or location information associated with client device 204 responsible for the alert (X). In a further example, the alert (X) may be mapped to user information associated with user 205 responsible for the alert (X).

At 490 in FIG. 4, context engine 119A may generate and send a context-aware intrusion detection alert (Z) to SDN controller 180. The context-aware intrusion detection alert (Z) may be generated by enhancing the alert (X) from IDS engine 118A with the context information from guest introspection agent 201. See 570-580 in FIG. 5.

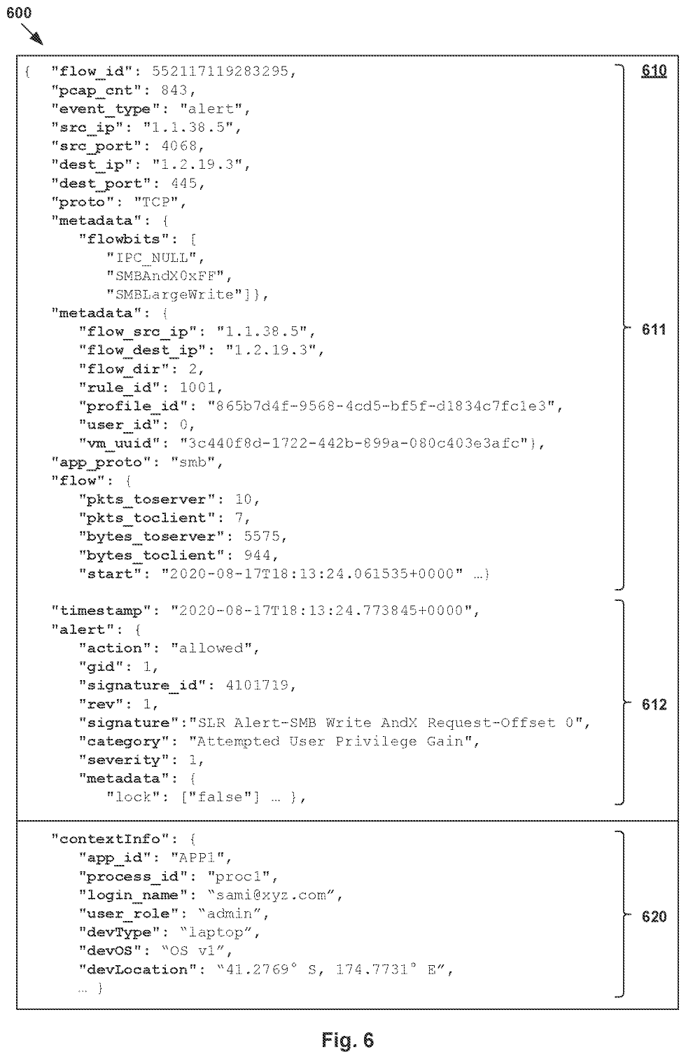

FIG. 6 is a schematic diagram illustrating example context-aware intrusion detection alert 600. At 610, the alert (X) may specify packet flow information and a matching IDS signature. At 611, the packet flow information may include: flow tuples (see “src_ip,” “src_port,” “dest_ip,” “dest_port” and “proto”), flow metadata (see “metadata”), flow metrics (see “pkts_toserver,” “pkts_toclient,” “bytes_toserver,” “bytes_toclient,”), etc. At 612, the matching IDS signature may be identified using the following: signature ID (see “signature_id”), alert timestamp (see “timestamp”), flow direction (see “flow_dir”), signature name (see “signature”=“SLR Alert SMB Write AndX Request Offset 0”), category (see “Attempted User Privilege”), severity, metadata, etc.

Further, at 620, the context information (contextInfo) mapped to the alert (X) may include process or application information (see “app_id” and “process_id”), hardware information (see “devType”), software information (see “devOS”), location information (see “devLocation”), user information (see “login_name” and “user_role”), etc. This way, the context information from guest introspection agent 201 may be used to enhance the alert (X) to identify the process/application (e.g., APP1 141), client device 204 and user 205 responsible for the alert (X).

(d) Context-aware remediation action

At 490 in FIG. 4, context engine 119A may trigger any suitable context-aware remediation action(s) based on the process/application (e.g., APP1 141), client device 204 and user 205 responsible for the alert (X). In a first example, in response to detecting alert(s) associated with a particular security threat (e.g., wannacry attack), the OS version may be assessed to determine whether a software patch is required to defend against the security attack. If yes, SDN controller 180 or host-A 110A may suggest user 205 to upgrade the OS running on client device 204 to an improved version. In a second example, in response to detecting alert(s) associated with user 205 and/or APP1 141, SDN controller 180 may instruct host-A 110A to block user 205 and/or APP1 141 from further network activity. If the alert(s) are caused by an insecure OS version, SDN controller 180 or host-A 110A may generate and send a reminder to client device 204. Once triggered, the remediation action(s) may be performed automatically, or after confirmation by a network administrator via SDN manager 184.

Container Implementation

Although explained using VMs, it should be understood that public cloud environment 100 may include other virtual workloads, such as containers, etc. As used herein, the term “container” (also known as “container instance”) is used generally to describe an application that is encapsulated with all its dependencies (e.g., binaries, libraries, etc.). In the examples in FIG. 1 to FIG. 6, container technologies may be used to run various containers inside respective VMs 131-134. Containers are “OS-less”, meaning that they do not include any OS that could weigh 10s of Gigabytes (GB). This makes containers more lightweight, portable, efficient and suitable for delivery into an isolated OS environment. Running containers inside a VM (known as “containers-on-virtual-machine” approach) not only leverages the benefits of container technologies but also that of virtualization technologies. The containers may be executed as isolated processes inside respective VMs.

Computer System

The above examples can be implemented by hardware (including hardware logic circuitry), software or firmware or a combination thereof. The above examples may be implemented by any suitable computing device, computer system, etc. The computer system may include processor(s), memory unit(s) and physical NIC(s) that may communicate with each other via a communication bus, etc. The computer system may include a non-transitory computer-readable medium having stored thereon instructions or program code that, when executed by the processor, cause the processor to perform process(es) described herein with reference to FIG. 1 to FIG. 6. For example, the instructions or program code, when executed by the processor of the computer system, may cause the processor to implement examples of the present disclosure.

The techniques introduced above can be implemented in special-purpose hardwired circuitry, in software and/or firmware in conjunction with programmable circuitry, or in a combination thereof. Special-purpose hardwired circuitry may be in the form of, for example, one or more application-specific integrated circuits (ASICs), programmable logic devices (PLDs), field-programmable gate arrays (FPGAs), and others. The term ‘processor’ is to be interpreted broadly to include a processing unit, ASIC, logic unit, or programmable gate array etc.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or any combination thereof.

Those skilled in the art will recognize that some aspects of the embodiments disclosed herein, in whole or in part, can be equivalently implemented in integrated circuits, as one or more computer programs running on one or more computers (e.g., as one or more programs running on one or more computing systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure.

Software and/or to implement the techniques introduced here may be stored on a non-transitory computer-readable storage medium and may be executed by one or more general-purpose or special-purpose programmable microprocessors. A “computer-readable storage medium”, as the term is used herein, includes any mechanism that provides (i.e., stores and/or transmits) information in a form accessible by a machine (e.g., a computer, network device, personal digital assistant (PDA), mobile device, manufacturing tool, any device with a set of one or more processors, etc.). A computer-readable storage medium may include recordable/non recordable media (e.g., read-only memory (ROM), random access memory (RAM), magnetic disk or optical storage media, flash memory devices, etc.).

The drawings are only illustrations of an example, wherein the units or procedure shown in the drawings are not necessarily essential for implementing the present disclosure. Those skilled in the art will understand that the units in the device in the examples can be arranged in the device in the examples as described or can be alternatively located in one or more devices different from that in the examples. The units in the examples described can be combined into one module or further divided into a plurality of sub-unit.

We claim:

1. A method for a computer system to perform context-aware intrusion detection, wherein the method comprises:
detecting a packet that is travelling from, or towards, a virtualized computing instance supported by the computer system;
in response to determination that there is a matching intrusion detection signature based on packet flow information associated with the packet,
generating an intrusion detection alert that identifies the matching intrusion detection signature and the packet flow information;
mapping the intrusion detection alert to contextual information associated with at least one of the following: the virtualized computing instance, a client device associated with the virtualized computing instance, and a user operating the client device; and
generating a context-aware intrusion detection alert to trigger a context-aware remediation action based on at least the contextual information, the context-aware intrusion detection alert being the intrusion detection alert that is enhanced with the contextual information.

2. The method of claim 1, wherein mapping the intrusion detection alert to the contextual information comprises:
monitoring, by a guest introspection agent running inside the virtualized computing instance, multiple packet flows associated with virtualized computing instance to generate flow-context information associated with the multiple packet flows.

3. The method of claim 2, wherein mapping the intrusion detection alert to the contextual information comprises:
obtaining, by a context engine running on the computer system, the flow-context information from the guest introspection engine; and
mapping, by the context engine, the intrusion detection alert to one of the multiple packet flows based on the flow-context information.

4. The method of claim 3, wherein mapping the intrusion detection alert to the contextual information comprises:
mapping, by the context engine, the intrusion detection alert to a particular packet flow from the multiple packet flows by comparing (a) an alert timestamp associated with the intrusion detection alert with (b) a start time or end time associated with the particular packet flow.

5. The method of claim 3, wherein generating an intrusion detection alert comprises:
generating and sending, by an intrusion detection system (IDS) engine running on the computer system, the intrusion detection alert to the context engine to cause the context engine to map the intrusion detection alert to contextual information.

6. The method of claim 1, wherein mapping the intrusion detection alert to the contextual information comprises one or more of the following:
mapping the intrusion detection alert to a process or application that is running inside the virtualized computing instance and responsible for the intrusion detection alert;
mapping the intrusion detection alert to hardware information, software information or location information associated with client device responsible for the intrusion detection alert; and
mapping the intrusion detection alert to user information associated with the user responsible for the intrusion detection alert.

7. The method of claim 6, wherein generating the context-aware intrusion detection alert comprises one or more of the following:
triggering a first remediation action based on the process or application responsible for the intrusion detection alert;
triggering a second remediation action based on the hardware information, software information or location information associated with client device responsible for the intrusion detection alert; and
triggering a third remediation action based on the user information associated with the user responsible for the intrusion detection alert.

8. A non-transitory computer-readable storage medium that includes a set of instructions which, in response to execution by a processor of a computer system, cause the processor to perform context-aware intrusion detection, wherein the method comprises:
detecting a packet that is travelling from, or towards, a virtualized computing instance supported by the computer system;
in response to determination that there is a matching intrusion detection signature based on packet flow information associated with the packet,
generating an intrusion detection alert that identifies the matching intrusion detection signature and the packet flow information;
mapping the intrusion detection alert to contextual information associated with at least one of the following: the virtualized computing instance, a client device associated with the virtualized computing instance, and a user operating the client device; and
generating a context-aware intrusion detection alert to trigger a context-aware remediation action based on at least the contextual information, the context-aware intrusion detection alert being the intrusion detection alert that is enhanced with the contextual information.

9. The non-transitory computer-readable storage medium of claim 8, wherein mapping the intrusion detection alert to the contextual information comprises:
monitoring, by a guest introspection agent running inside the virtualized computing instance, multiple packet flows associated with virtualized computing instance to generate flow-context information associated with the multiple packet flows.

10. The non-transitory computer-readable storage medium of claim 9, wherein mapping the intrusion detection alert to the contextual information comprises:
obtaining, by a context engine running on the computer system, the flow-context information from the guest introspection engine; and
mapping, by the context engine, the intrusion detection alert to one of the multiple packet flows based on the flow-context information.

11. The non-transitory computer-readable storage medium of claim 10, wherein mapping the intrusion detection alert to the contextual information comprises:
mapping, by the context engine, the intrusion detection alert to a particular packet flow from the multiple packet flows by comparing (a) an alert timestamp associated with the intrusion detection alert with (b) a start time or end time associated with the particular packet flow.

12. The non-transitory computer-readable storage medium of claim 10, wherein generating an intrusion detection alert comprises:
generating and sending, by an intrusion detection system (IDS) engine running on the computer system, the intrusion detection alert to the context engine to cause the context engine to map the intrusion detection alert to contextual information.

13. The non-transitory computer-readable storage medium of claim 8, wherein mapping the intrusion detection alert to the contextual information comprises one or more of the following:
mapping the intrusion detection alert to a process or application that is running inside the virtualized computing instance and responsible for the intrusion detection alert;
mapping the intrusion detection alert to hardware information, software information or location information associated with client device responsible for the intrusion detection alert; and
mapping the intrusion detection alert to user information associated with the user responsible for the intrusion detection alert.

14. The non-transitory computer-readable storage medium of claim 13, wherein generating the context-aware intrusion detection alert comprises one or more of the following:
triggering a first remediation action based on the process or application responsible for the intrusion detection alert;
triggering a second remediation action based on the hardware information, software information or location information associated with client device responsible for the intrusion detection alert; and
triggering a third remediation action based on the user information associated with the user responsible for the intrusion detection alert.

15. A computer system, comprising:
(a) an intrusion detection system (IDS) engine to:
detect a packet that is travelling from, or towards, a virtualized computing instance supported by the computer system;
in response to determination that there is a matching intrusion detection signature based on packet flow information associated with the packet, generate an intrusion detection alert that identifies the matching intrusion detection signature and the packet flow information; and
(b) a context engine to:
map the intrusion detection alert to contextual information associated with at least one of the following: the virtualized computing instance, a client device associated with the virtualized computing instance, and a user operating the client device; and
generate a context-aware intrusion detection alert to trigger a context-aware remediation action based on at least the contextual information, the context-aware intrusion detection alert being the intrusion detection alert that is enhanced with the contextual information.

16. The computer system of claim 15, further comprising a guest introspection agent running inside the virtualized computing instance to:
monitor multiple packet flows associated with virtualized computing instance to generate flow-context information associated with the multiple packet flows.

17. The computer system of claim 16, wherein the context engine is to map the intrusion detection alert to the contextual information by performing the following:
obtain the flow-context information from the guest introspection engine; and
map the intrusion detection alert to one of the multiple packet flows based on the flow-context information.

18. The computer system of claim 17, wherein the context engine is to map the intrusion detection alert to the contextual information by performing the following:
map the intrusion detection alert to a particular packet flow from the multiple packet flows by comparing (a) an alert timestamp associated with the intrusion detection alert with (b) a start time or end time associated with the particular packet flow.

19. The computer system of claim 15, wherein the context engine is to map the intrusion detection alert to the contextual information by performing one or more of the following:
map the intrusion detection alert to a process or application that is running inside the virtualized computing instance and responsible for the intrusion detection alert;
map the intrusion detection alert to hardware information, software information or location information associated with client device responsible for the intrusion detection alert; and
map the intrusion detection alert to user information associated with the user responsible for the intrusion detection alert.

20. The computer system of claim 19, wherein the context engine is to generate the context-aware intrusion detection alert by performing one or more of the following:
trigger a first remediation action based on the process or application responsible for the intrusion detection alert;
trigger a second remediation action based on the hardware information, software information or location information associated with client device responsible for the intrusion detection alert; and
trigger a third remediation action based on the user information associated with the user responsible for the intrusion detection alert.
